(19) United States
(12) Patent Application Publication
(10) Pub. No.: US 2010/0288848 A1
(43) Pub. Date: Nov. 18, 2010

(54) HEAD SPRAY SYSTEM OF REACTOR PRESSURE VESSEL

(75) Inventor: Kazuhiro KAMEI, Kanagawa-ken (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 12/779,257

(22) Filed: May 13, 2010

(30) Foreign Application Priority Data
May 15, 2009 (JP) 2009-118880

(51) Int. Cl. B05B 15/00

(52) U.S. Cl. 239/70; 239/74

(57) ABSTRACT

A head spray system of a reactor pressure vessel includes a head spray line, a check valve, a vent line, a vent line shut-off valve, and an interlock mechanism. The head spray line supplies cooling water into the reactor pressure vessel when shutting down a reactor. The check valve is set up on the head spray line. The vent line which is connected to the head spray line evacuates a noncondensable gas. The vent line shut-off valve is set up on the vent line, and is open during normal plant operation. The interlock mechanism closes the vent line shut-off valve when a certain period of time has passed from the time of detecting a supply of the cooling water to the head spray line.

### CROSS REFERENCE TO RELATED APPLICATION

This application is based upon and claims the benefit of priority from the prior Japanese Patent Application No. 2009-118880, filed on May 15, 2009, the entire contents of which are incorporated herein by reference.

### FIELD

The present invention relates to a head spray system of a reactor pressure vessel in a nuclear plant.

### BACKGROUND

As shown in FIG. 17, a typical boiling water reactor (BWR) plant is provided with a head spray line 3 capable of spraying cooling water from a top part of a reactor pressure vessel (RPV) 1 in order to cool down the top part of RPV 1 in a reactor shutdown process. The head spray line 3 has a spray nozzle at the end thereof, thereby forming a structure capable of spraying water into RPV 1 (head spraying) through a check valve 4 on the head spray line 3.

A reactor core 17 is contained in RPV 1 of a BWR plant, and is dipped in reactor cooling water. The inside of RPV 1 is partitioned into a liquid phase part 18 to pool the reactor cooling water and a gaseous phase part 16 above the liquid phase part 18.

In the BWR plant with such a structure, there exist a noncondensable gas such as hydrogen or oxygen which is a product made from the decomposition of the cooling water as a result of neutron irradiation that nuclear reaction involves in the reactor core 17. In some cases, there exists Kr or Xe, i.e., a radioactive noble gas which leaks in minute amounts from a fuel rod. Rapid combustion can be caused if the noncondensable gas, e.g., hydrogen is ignited for some reasons. Therefore, a pipe 40 is provided to the BWR plant to be connected to a main steam pipe from the top part of RPV 1. Thereby, the BWR plant is provided with a system capable of leading the noncondensable gas to a steam condenser through a main steam system to perform gaseous waste disposal.

In the above-mentioned head spray line 3, a pipe line uprises from the spray nozzle 8. Therefore, the noncondensable gas can be accumulated in the pipe line between the spray nozzle 8 and the check valve 4 when the head spraying is not performed. For this reason, a vent line 11 is set up to allow it to always evacuate the noncondensable gas so that the noncondensable gas is led to the side of a main steam pipe 41 and a steam condenser.

A shut-off valve 12 is provided to the vent line 11. The shut-off valve 12 is remotely-operable and open during normal plant operation in order to evacuate the noncondensable gases. When the head spraying was performed, the shut-off valve 12 was closed with an open enabling signal for an isolation valve 5 of a reactor containment vessel to start the head spraying. Therefore, the shut-off valve 12 was fully closed before the head spraying so that sprayed water did not become a bypass flow to continuously go to a vent.

A reactor core isolation cooling (RCIC) system to supply cooling water to RPV 1 for isolating a reactor core may use the head spray line 3 in some plants. This shared head spray line 3 is also provided with a means of preventing the noncondensable gas from accumulating (not shown).

As mentioned above, the shut-off valve was fully closed before starting the head spraying. This provided a conventional BWR plant with a means of maintaining a function for the head spraying to completely eliminate a bypass flow to the vent when the top part of the conventional BWR plant underwent the head spraying. However, when starting the head spraying under this condition, a saturation vapor is trapped in the pipe line between the branching point of the noncondensable gas vent line of the head spray line 3 and the vent line shut-off valve 12. When the trapped saturation vapor contacts the sprayed water, i.e., subcool water, the saturation vapor condenses rapidly so that water is suck into the pipe line whose end is closed with the shut-off valve 12. Therefore, there is a risk of causing water hammer at the shut-off valve 12, i.e., applying an excessive pressure to the head spray system. Therefore, it has been desired to develop a head spray system capable of preventing water hammer due to vapor condensation in the vent line thereof at the time of the head spraying.

### BRIEF DESCRIPTION OF THE DRAWINGS

Aspects of this disclosure will become apparent upon reading the following detailed description and upon reference to the accompanying drawings. The description and the associated drawings are provided to illustrate embodiments of the invention and not limited to the scope of the invention.

FIG. 1 is a diagram showing a configuration of a head spray system of a reactor pressure vessel according to a first embodiment of the invention.

FIG. 2 is a block diagram showing a configuration of an interlock mechanism according to the first embodiment.

FIG. 3 is a diagram showing a configuration of a head spray system of a reactor pressure vessel according to a second embodiment of the invention.

FIG. 4 is a block diagram showing a configuration of an interlock mechanism according to the second embodiment.

FIG. 5 is a diagram showing a configuration of a head spray system of a reactor pressure vessel according to a third embodiment of the invention.

FIG. 6 is a diagram showing a configuration of an interlock mechanism according to the third embodiment.

FIG. 7 is a diagram showing a configuration of a head spray system of a reactor pressure vessel according to a fourth embodiment of the invention.

FIG. 8 is a diagram showing a configuration of a head spray system of a reactor pressure vessel according to a fifth embodiment of the invention.

FIG. 9 is a block diagram showing a configuration of an interlock mechanism according to the fifth embodiment.

FIG. 10 is a diagram showing a configuration of a head spray system of a reactor pressure vessel according to a sixth embodiment of the invention.

FIG. 11 is a block diagram showing a configuration of an interlock mechanism according to the sixth embodiment.

FIG. 12 is a diagram showing a modified example of the head spray system of a reactor pressure vessel according to the sixth embodiment.

FIG. 13 is a block diagram showing a modified example of the interlock mechanism according to the sixth embodiment.

FIG. 14 is a diagram showing another modified example of the head spray system of a reactor pressure vessel according to the sixth embodiment.

FIG. 15 is a block diagram showing another modified example of the interlock mechanism according to the sixth embodiment.

FIG. 16 is a diagram showing a configuration of a head spray system of a reactor pressure vessel according to a seventh embodiment.

FIG. 17 is a diagram showing a configuration of a conventional head spray system of a reactor pressure vessel.

### DETAILED DESCRIPTION

According to an embodiment of the invention, a head spray system of a reactor pressure vessel includes a head spray line, a check valve, a vent line, a vent line shut-off valve, and an interlock mechanism. The head spray line supplies cooling water into the reactor pressure vessel when shutting down a reactor. The check valve is set up on the head spray line. The vent line which is connected to the head spray line evacuates a noncondensable gas. The vent line shut-off valve is set up on the vent line, and is open during normal plant operation. The interlock mechanism closes the vent line shut-off valve when a certain period of time has passed from the time of detecting a supply of the cooling water to the head spray line.

Embodiments will be explained below with reference to the accompanying drawings.

### First Embodiment

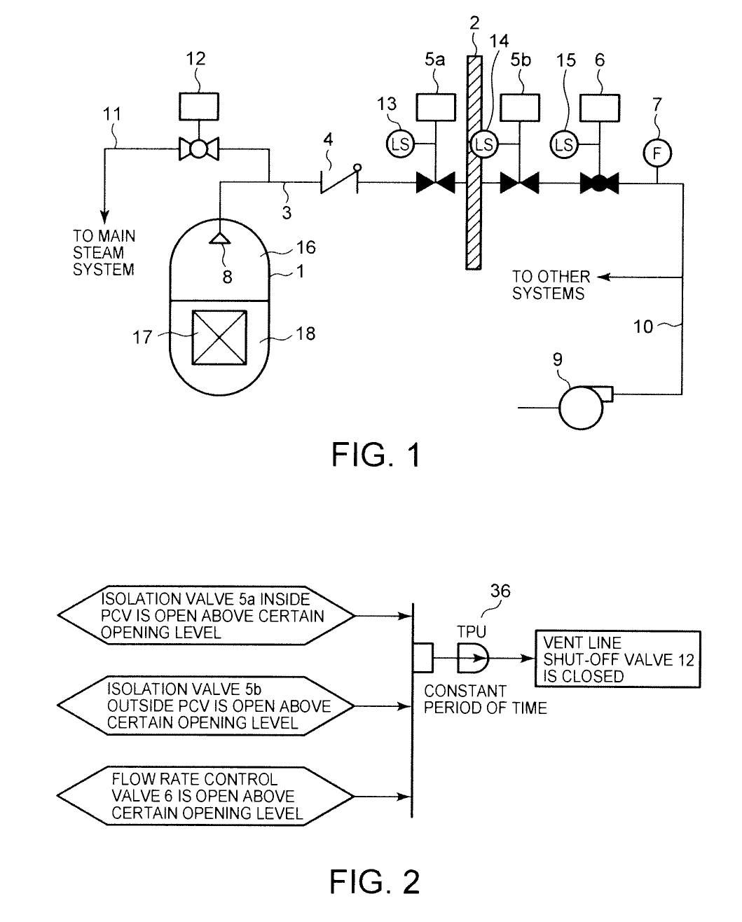

FIG. 1 is a diagram showing a configuration of a head spray system according to a first embodiment of the invention. FIG. 2 is a block diagram showing a configuration of an interlock mechanism according to the first embodiment. The head spray system according to the first embodiment will be explained with reference to FIGS. 1 and 2.

A head spray system to be used in a reactor shutdown process is provided with a head spray line 3 capable of spraying cooling water from the top part of RPV 1 (head spraying). The head spray line 3 is provided with a spray nozzle 8 at the end thereof, forming a structure capable of spraying water through a check valve 4 on the head spray line 3.

A reactor core 17 is contained in RPV 1 of a BWR plant, and is dipped in reactor cooling water. The inside of RPV 1 is divided into a liquid phase part 18 to pool reactor cooling water and a gaseous phase part 16 above the liquid phase part 18. The water supplied with a pump 9 is sprayed into RPV 1 from the top part of RPV 1 (head spraying) through a pump output line 10 and the head spray line 3. Alternatively, the pump 9 may be used for other uses. Then, a pipe of other line is connected to the pump output line 10.

A flow rate control valve 6, an isolation valve 5a inside PCV, an isolation valve 5b outside PCV, a check valve 4 and a flowmeter 7 are set up on the head spray line 3. The noncondensable gas can be accumulated in the pipe line between RPV 1 and the check valve 4 lying most downstream among these valves during normal plant operation. Therefore, a vent line 11 is set up in order to allow it to always evacuate the noncondensable gas.

It is required to flow steam through the vent line 11 at any time. Therefore, the vent line 11 is connected to a main steam system having a steam flow during normal plant operation. A shut-off valve 12 to be remotely-operable is set up on the vent line 11, and prevents a bypass stream from flowing into a vent during the head spraying.

An isolation valve 5a inside PCV, an isolation valve 5b outside PCV and a flow rate control valve 6 on the head spray line 3 are remotely-operable, and limit switches are provided to these valves respectively to indicate the switching conditions thereof.

Moreover, an interlock mechanism is provided to serve as shown in FIG. 2. The interlock mechanism closes the vent line shut-off valve 12 when a certain period of time has passed from the time of meeting the requirement shown in FIG. 2 that all of the isolation valve 5a inside PCV, the isolation valve 5b outside PCV and the flow rate control valve 6 are open above a certain opening level. In FIG. 2, TPU means a time pulse unit. Also in FIGS. 4, 6, 9, 11, 13, and 15, TPU has the same meaning.

The head spray system made thus according to the first embodiment serves as follows when performing the head spraying. During normal plant operation, the vent line shut-off valve 12 is set open, while all of the isolation valve 5a inside PCV, the isolation valve 5b outside PCV and a flow rate control valve 6 are set to close in order to evacuate the noncondensable gas. In a reactor shutdown process, the head spray system puts a pump 9 into operation beforehand, and then sets the isolation valve 5a inside PCV, the isolation valve 5b outside PCV and the flow rate control valve 6 open to allow water to flow out. Subsequently, the head spray system sets the check valve 4 open to finally supply water into RPV 1.

The vent line shut-off valve 12 is set open for a given length of time after water starts to flow into the head spray line 3, thereby passing the water through the vent line 11. Sufficient time is taken for the water to reach the vent line shut-off valve 12. After the sufficient time passes, the interlock mechanism shown in FIG. 2 closes the vent line shut-off valve 12.

The above-mentioned switching of the vent line shut-off valve 12 due to the interlock mechanism allows it to eliminate saturation steam in the pipe line between the branching point of the vent line 3 and the vent line shut-off valve 12, thereby preventing water hammer due to rapid vapor condensation. Moreover, unless a line having a dead end lies downstream of the vent line shut-off valve 12, similar water hammer does not happen. When the vent line shut-off valve 12 closes during the head spraying, a rated flow of the head spraying can be supplied into RPV 1, thereby allowing the present system to fulfill its function.

In the operation of the head spray line, the flow rate control valve 6 opens last among the isolation valve 5a inside PCV, the isolation valve 5b outside PCV and the flow rate control valve 6. Therefore, even if a signal carrying the valve opening level in FIG. 2 is confined to the flow rate control valve 6, it is possible to prevent water hammer.

According to the first embodiment, the head spray system is provided with an interlock mechanism. The interlock mechanism closes the vent line shut-off valve when a certain period of time from the time of detecting a cooling water supply to the head spray line, thereby allowing it to cool down the top part of RPV in a reactor shutdown process and evacuate the noncondensable gas during normal plant operation while preventing an excessive pressure due to water hammer from being applied to the head spray line. Therefore, according to the first embodiment, it is possible to provide a safer and more reliable head spray system of a reactor pressure vessel.

### Second Embodiment

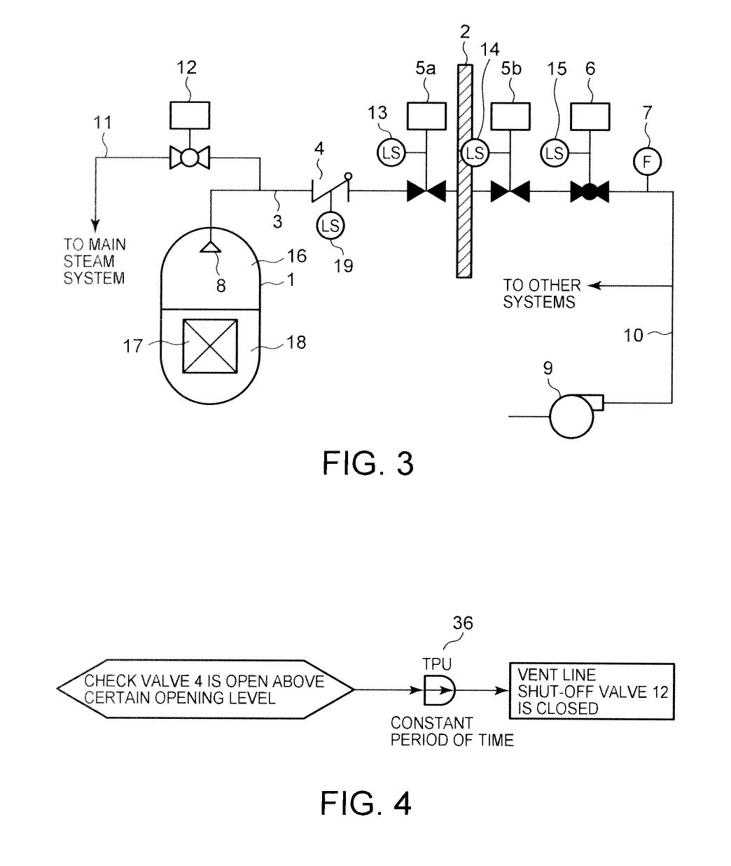

FIG. 3 is a diagram showing a configuration of a head spray system of a reactor pressure vessel according to a second embodiment of the invention. FIG. 4 is a block diagram showing a configuration of an interlock mechanism according to the second embodiment. The head spray system according to the second embodiment will be explained with reference to FIGS. 3 and 4. The head spray system of the second embodiment differs from that of the first embodiment in a point that a limit switch is provided to the head spray line 3 instead of the check valve 4 sending a signal for closing the vent line shut-off valve 12 in accordance with the opening level of the check valve. The configuration and operation of the head spray system of the second embodiment other than the point is the same as that of the first embodiment.

As shown in FIG. 4, the limit switch 19 detects the opening of the check valve 4 above a certain level to close the vent line shut-off valve 12 when a constant period of time has passed from the time of the detecting in the second embodiment. As mentioned above, the vent line shut-off valve 12 is closed in accordance with the opening level of the check valve 4 in the second embodiment, thereby allowing it to surely prevent water hammer as well as in the first embodiment.

Some plants are provided with check valves instead of the isolation valve 5a inside PCV and the isolation valve 5b outside PCV. In this case, even if the opening level signal of the check valve 4 shown in FIG. 4 is received from at least one valve of the valves other than the check valve 4 on the head spray line 3, the effect for preventing water hammer can be obtained.

### Third Embodiment

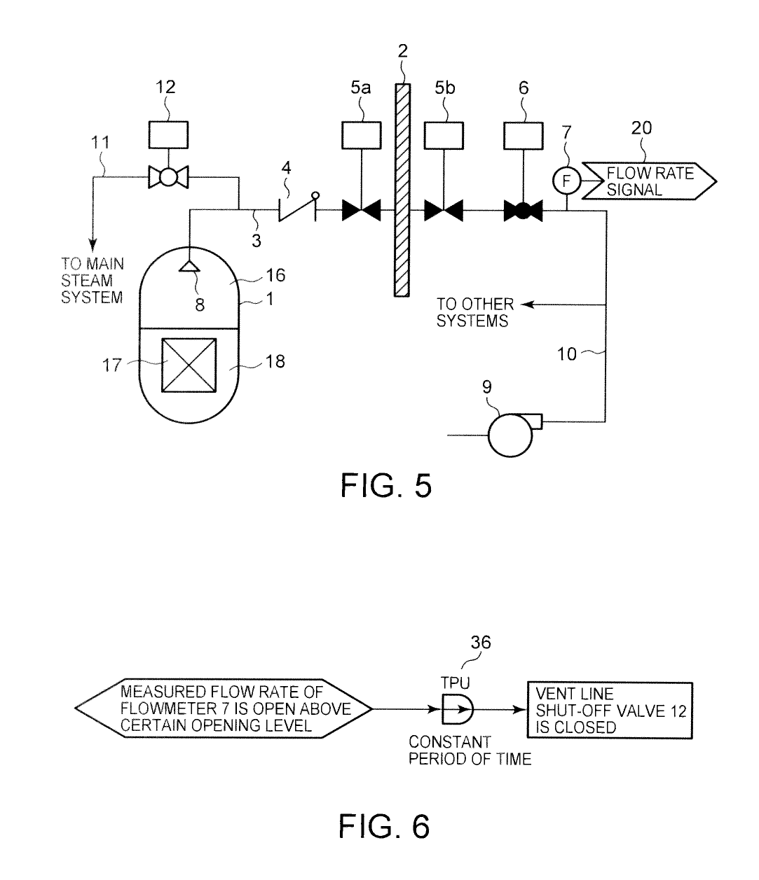

FIG. 5 is a diagram showing a configuration of a head spray system of a reactor pressure vessel according to a third embodiment of the invention. FIG. 6 is a block diagram showing a configuration of an interlock mechanism according to the third embodiment. The head spray system according to the third embodiment will be explained with reference to FIGS. 5 and 6. In the third embodiment, a closing signal is characteristically transmitted to the vent line shut-off valve 12 in accordance with a flow signal 20 of the flowmeter 7 on the head spray line 3.

As shown in FIG. 6, the vent line shut-off valve 12 is closed when a certain period of time has passed after the flow signal 20 of the flowmeter 7 on the head spray line 3 reaches above a certain level of a flow rate. As mentioned above, the vent line shut-off valve 12 is closed in accordance with the flow signal 20 of the flowmeter 7 in the third embodiment, thereby allowing it to surely prevent water hammer as well as in the first and second embodiments.

### Fourth Embodiment

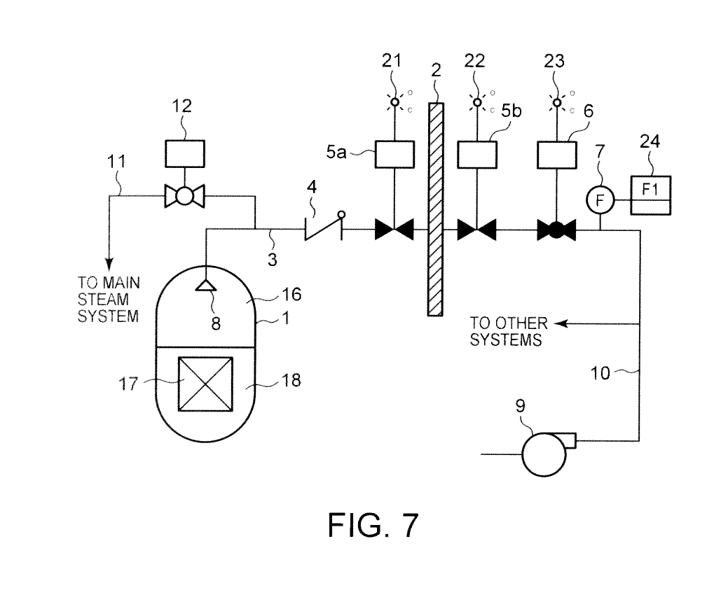

FIG. 7 is a diagram showing a configuration of a head spray system of a reactor pressure vessel according to a fourth embodiment of the invention. The head spray system according to the fourth embodiment will be explained below with reference to FIG. 7. In the fourth embodiment, the flow signal of the flowmeter on the head spray line, an opening level of the flow rate control valve, and the opening/closing states of the isolation valve 5a inside PCV and the isolation valve 5b outside PCV are characteristically displayed in a control booth through functions 21 to 24.

In the fourth embodiment, an operator checks the flow signal 24 of the flowmeter, the opening level of the flow rate control valve, and the opening/closing states of the isolation valve 5a inside PCV and the isolation valve 5b outside PCV with a display device in the control booth, and operates to close the vent line shut-off valve 12 from the control booth when a certain period of time has passed from the time of checking that water is flowing through the head spray line 3.

Thereby, water hammer due to vapor condensation in the vent line 11 is prevented still more certainly. When the vent line shut-off valve 12 is closed during the head spraying, it is possible to supply a rated flow for the head spraying to RPV 1, thereby allowing it to fulfill a function of the present head spray system.

### Fifth Embodiment

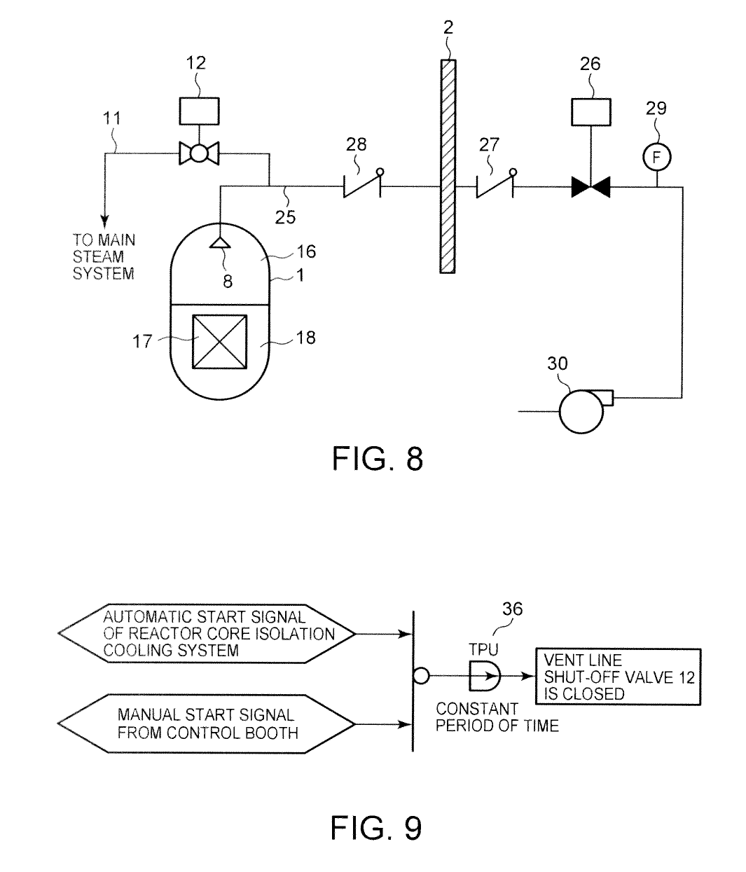

FIG. 8 is a diagram showing a configuration of a head spray system of a reactor pressure vessel according to a fifth embodiment of the invention. FIG. 9 is a block diagram showing a configuration of an interlock mechanism according to the fifth embodiment. The head spray system according to the fifth embodiment will be explained below with reference to FIGS. 8 and 9. In a plant where a RCIC system to supply cooling water to RPV 1 for isolating a reactor core provides injection line on the top of RPV 1, the RCIC system and a reactor shutdown cooling system share the injection line of the head spray system.

An injection valve 26, a PCV separation valve 27, a check valve and a flowmeter 29 are set up on the head spray line 25 which is a pump output line of a RCIC system. The noncondensable gas can be accumulated in the pipe line between RPV 1 and the check valve 28 lying most downstream among these valves during normal plant operation. Therefore, a vent line 11 is set up in order to allow it to evacuate the noncondensable gas at any time.

It is required to flow steam through the vent line 11 at any time. Therefore, the vent line 11 is connected to a main steam system having a steam flow during normal plant operation. A shut-off valve 12 to be remotely-operable is set up on the vent line 11, and allows it to prevent a bypass stream from flowing into a vent during the head spraying. A pump 30 starts to open the injection valve 26 in accordance with an automatic start signal of a RCIC system or a manual start signal from a control booth. As shown in FIG. 9, the vent line shut-off valve 12 is closed when a certain period of time has passed from the time of receiving the automatic start signal of the RCIC system or the manual start signal from the control booth.

In the fifth embodiment configured thus, the head spray system operates for the head spraying as follows. During normal plant operation, the vent line shut-off valve 12 is open and the injection valve 26 is closed so that the noncondensable gas is evacuated. The RCIC system needs to start the pump 30 and fully open the injection valve 26 within a required period of time after receiving the start signal, thereby injecting a rated flow of water into RPV 1. The vent line shut-off valve 12 is kept open for a given length of time after water starts to flow into the head spray line 25, thereby injecting water through the vent line 11.

Plenty of time is taken for the water to reach the vent line shut-off valve 12. After the passage of the plenty of time, the interlock mechanism closes the vent line shut-off valve 12. The above-mentioned switching of the vent line shut-off valve 12 allows it to remove saturated steam trapped in the pipe line between the connecting point of the vent line 3 and the vent line shut-off valve 12, thereby preventing water hammer due to rapid vapor condensation.

Moreover, unless a line with a fully closed end including saturated steam lies downstream of the vent line shut-off valve 12, similar water hammer does not happen. The RCIC system fully closes the vent line shut-off valve 12 to prevent the bypass flow from being formed within a required period of time from the time of receiving the start signal to the time of injecting a rated flow of water, thereby allowing it to fulfill the required function thereof.

According to the fifth embodiment, it is possible to provide a safer and more reliable head spray system of a reactor pressure vessel. The system is capable of supplying cooling water to RPV 1 for isolating a reactor core and evacuating the noncondensable gas during normal plant operation while avoiding a risk that an excessive pressure is applied to the cooling system thereof by water hammer due to vapor condensation.

### Sixth Embodiment

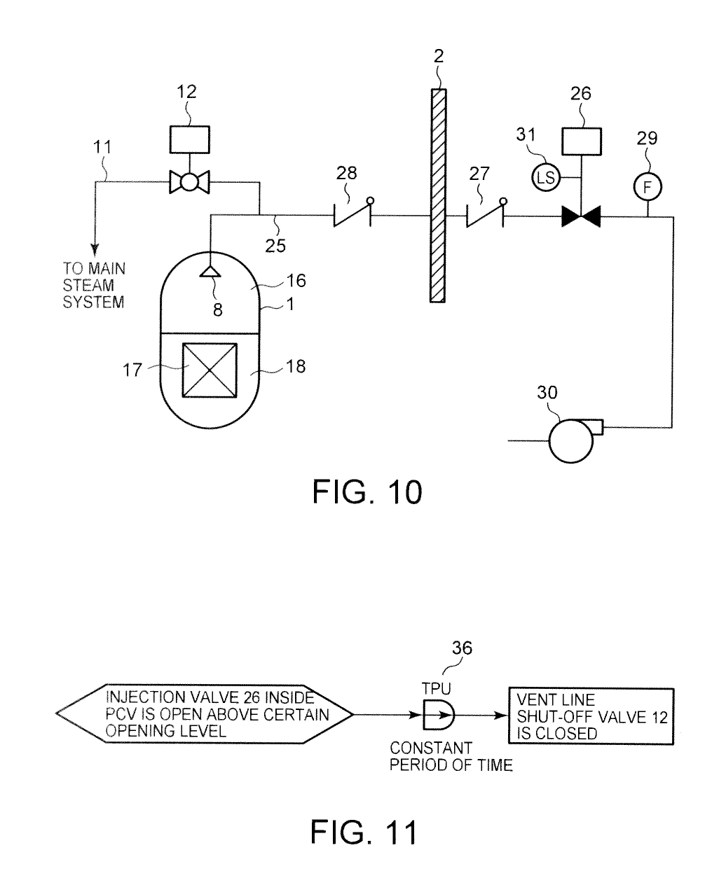

FIG. 10 is a diagram showing a configuration of a head spray system of a reactor pressure vessel according to a sixth embodiment of the invention. FIG. 11 is a block diagram showing a configuration of an interlock mechanism according to the sixth embodiment. The head spray system according to the sixth embodiment will be explained below with reference to FIGS. 10 and 11. In the sixth embodiment, the head spray system characteristically sends a closing signal to the head spray shut-off valve 12 in accordance with a signal of the injection valve 26 on a pump vent line 25 of the RCIC system. As shown in FIG. 11, the vent line shut-off valve 12 is closed when a certain period of time has passed after the injection valve 26 is open above a certain opening level to make a limit switch work.

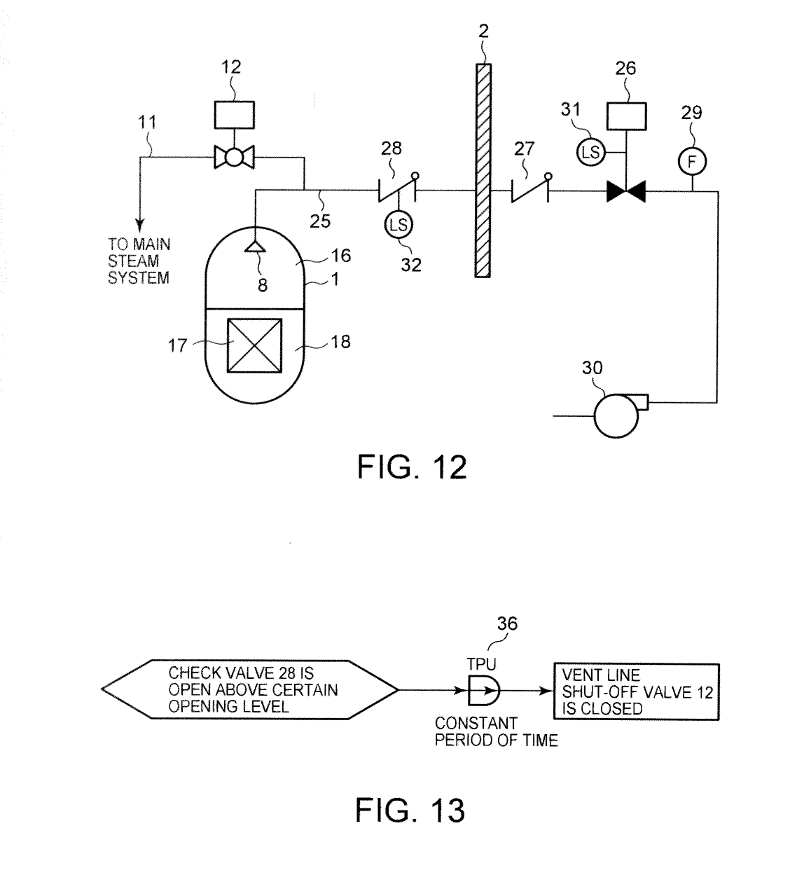

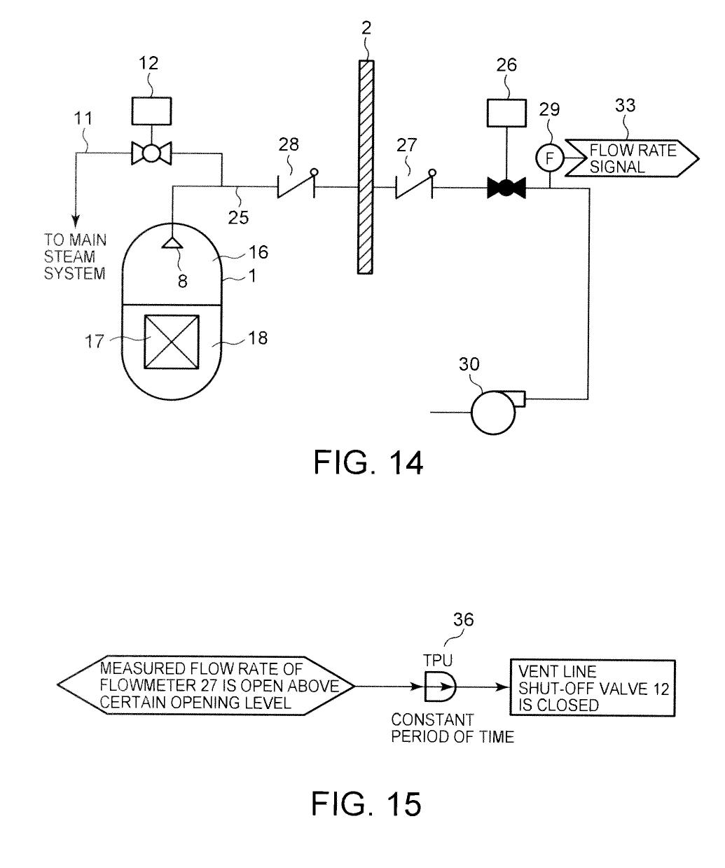

FIG. 12 is a diagram showing a modified example of the head spray system of a reactor pressure vessel according to the sixth embodiment. FIG. 13 is a block diagram showing a modified example of the interlock mechanism according to the sixth embodiment. Alternatively, the check valve 28 may be set up instead of setting up the limit switch to the injection valve 26 as shown in FIGS. 12 and 13. Then, the vent line shut-off valve 12 is closed when a set period of time has passed after the check valve is open above a certain opening level to make the limit switch work. Furthermore, as shown in FIG. 14 and FIG. 15, a closing signal may be transmitted to the vent line shut-off valve 12 in accordance with a flow rate signal 33 of the flowmeter 29. FIG. 14 is a diagram showing another modified example of the head spray system of a reactor pressure vessel according to the sixth embodiment. FIG. 15 is a block diagram showing another modified example of the interlock mechanism according to the sixth embodiment.

According to the sixth embodiment, the vent line shut-off valve 12 is closed in accordance with the signal of the injection valve 26 or the limit switch of the check valve 28, or the flow rate signal 33, thereby allowing it to certainly prevent water hammer.

### Seventh Embodiment

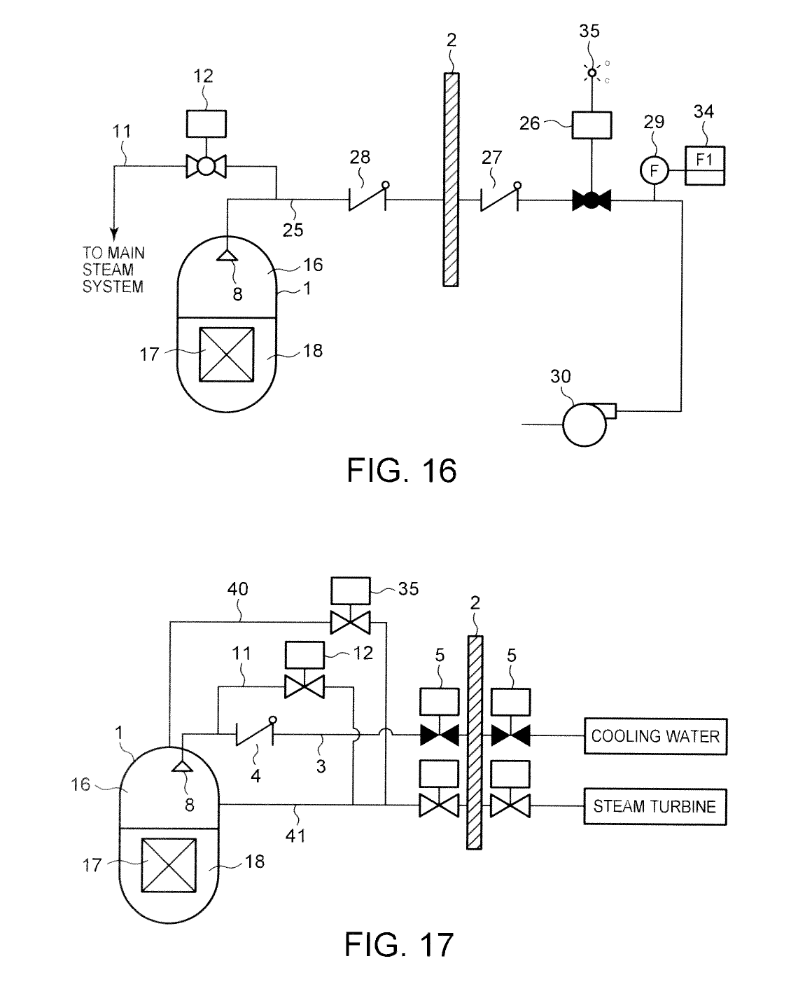

FIG. 16 is a diagram showing a configuration of a head spray system of a reactor pressure vessel according to a seventh embodiment of the invention. The head spray system will be explained with reference to FIG. 16. In the seventh embodiment, the flow rate signal 33 of the flowmeter 29 on the pump vent line 25 of the RCIC system and opening/closing states of the injection valve 26 are transmitted to a central control booth to be displayed therein.

In the seventh embodiment, an operator checks a flow signal 33 of the flowmeter 29, and the opening/closing states of the injection valve 26 with a display device, and closes the vent line shut-off valve 12 from the control booth when a certain period of time has passed from the time of checking that water is flowing through the head spray line 11. This allows it to prevent water hammer due to rapid vapor condensation in the vent line 11.

The RCIC system fully closes the vent line shut-off valve 12 to prevent the bypass flow from being formed within a required period of time from the time of receiving the start signal to the time of injecting a rated flow of water, thereby allowing it to fulfill the required function thereof.

While certain embodiments of the invention have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A head spray system of a reactor pressure vessel, comprising:
a head spray line to supply cooling water into the reactor pressure vessel when shutting down a reactor;
a check valve set up on the head spray line;
a vent line which is connected to the head spray line to evacuate a noncondensable gas;
a vent line shut-off valve set up on the vent line to be open during normal plant operation; and
an interlock mechanism to close the vent line shut-off valve when a certain period of time has passed from the time of detecting a supply of the cooling water to the head spray line.

2. The head spray system according to claim 1, wherein the interlock mechanism closes the vent line shut-off valve when a set period of time has passed from the time of opening the check valve above a certain opening level.

3. The head spray system according to claim 1, wherein two or more valves are set up on the head spray line in addition to the check valve, and the interlock mechanism closes the vent line shut-off valve when a set period of time has passed from the time of opening at least one of the two or more valves above a set opening level.

4. The head spray system according to claim 1, wherein a flowmeter is set up on the head spray line, and the interlock mechanism closes the vent line shut-off valve when a set period of time has passed from the time of rise of a measured flow rate of the flowmeter above a set level.

5. The head spray system according to claim 3, wherein a display device is set up in a control booth to display switching conditions of the two or more valves or a flow rate signal of the flowmeter, and the interlock mechanism closes the vent line shut-off valve when a set period of time has passed from the time of checking with the display device that the cooling water is supplied to the head spray line.

6. The head spray system according to claim 1, wherein a reactor core isolation cooling system is connected to the head spray line, and the interlock mechanism closes the vent line shut-off valve when a set period of time has passed from the time of receiving a start signal of the reactor core isolation cooling system.
